(19) United States
(12) Patent Application Publication
(10) Pub. No.: US 2022/0405757 A1
(43) Pub. Date: Dec. 22, 2022

(54) Mobile Money Management System

(71) Applicant: Christian Hansen, West Lakeland, MN (US)

(72) Inventor: Christian Hansen, West Lakeland, MN (US)

(21) Appl. No.: 17/838,401

(22) Filed: Jun. 13, 2022

Related U.S. Application Data
(60) Provisional application No. 63/212,391, filed on Jun. 18, 2021.

(51) Int. Cl. G06Q 20/40; G06Q 20/20

(52) U.S. Cl. CPC G06Q 20/4015; G06Q 20/20

(57) ABSTRACT

A mobile money management system, apparatus and method for conducting financial transactions using mobile devices, and more particularly to the use of cellular telephones or other handheld or wearable personal computing devices, for organizing and presenting information related to financial transactions, including sales transactions via a wireless communication link.

### RELATED APPLICATION INFORMATION

This application claims the benefit of U.S. Provisional Application No. 63/212,391 (filed Jun. 18, 2021), the contents of which are fully incorporated herein by reference.

### TECHNICAL FIELD

The present technology is generally related to systems, apparatuses, and methods for conducting financial transactions using mobile devices, and more particularly to the use of cellular telephones or other handheld or wearable personal computing devices, for organizing and presenting information related to financial transactions, including sales transactions via a wireless communication link.

### BACKGROUND

Despite the availability of alternative payment options, cash remains a popular form of payment, particularly for small value purchases. It is estimated that approximately 25% of all purchases are made in cash. The estimate jumps to nearly 50% for in-person purchases of under $10, with individuals under the age of 25 being the most likely of any age group to use cash.

Unfortunately, the use of cash is often times an inconvenient process. For example, many consumers receive payment from their employers in the form of a check, which is often electronically deposited at a bank where the consumer has a savings account. The consumer must then physically visit either the bank or an automated teller machine (ATM) to withdraw a portion of their savings in the form of cash for future purchases. After withdrawing the cash, the consumer must then transport the cash to a place of business in order to purchase goods and services. While in possession of cash, there is a risk that the cash will be lost. Moreover, although the consumer is often provided a receipt for their cash transactions, creating a detailed accounting of cash expenditures can be a burdensome task, as it typically involves manual tabulation of paper receipts.

The use of a credit or debit card presents a more efficient process, as it eliminates the need of the consumer to physically visit a bank or ATM prior to making a purchase. As an added benefit, there is also a typically an electronic record of transactions associated with the credit or debit card, which significantly eases the burden of creating a detailed accounting of expenditures. Still, the use of a credit or debit card requires removal of the card from a consumer's wallet or pocket, as the card must be either swiped or inserted into a chip reader in order to participate in the transaction. Removal of the card from a wallet or pocket presents a risk that the card will be inadvertently misplaced during the transaction. Although generally much safer than cash, lost credit and debit cards may be used by nefarious third parties to make purchases until the card is reported as being lost or stolen.

The most efficient and secure method of payment is through contactless systems, such as smart cards or chips. Smart cards and chips are stored value products, which maintain a stored value of funds accessible by the consumer. The card or chip is considered “smart,” because the stored value may be added to and subtracted from locally (e.g., a merchant's card reader or point-of-sale terminal), without the need to access a central facility. Such cards or chips may be contactless, in that they communicate with a card reader or other point-of-sale terminal using radio frequency (RF) technology, and where positioning the card or chip in proximity to the card reader enables the transfer of data needed to complete the purchase. In some cases, the contactless card or chip may be embedded in, or otherwise incorporated into a mobile device such as a mobile phone.

Although contactless payment methods have recently gained the attention of a number of large businesses (e.g., Apple, Google, Samsung, etc.), contactless payment methods are still in their infancy, and have been particularly slow to catch on in the United States among other countries. Moreover, despite recent advances, current systems are wracked with inefficiencies which can be a deterrent to many users. Further improvements in organization, usability, and control are always desired. The present disclosure addresses these concerns.

### SUMMARY OF THE DISCLOSURE

The techniques of this disclosure generally relate to systems, apparatuses, and methods for conducting financial transactions using mobile devices, and more particularly to the use of cellular telephones or other handheld or wearable personal computing devices, for organizing and presenting information related to financial transactions, including sales transactions via a wireless communication link.

One embodiment of the present disclosure provides a mobile money management system including a data engine configured to wirelessly communicate data concerning a financial transaction with a point-of-sale (POS) terminal located at a place of business, and a user interface configured to enable a user to define one or more rules for establishing selection of a payment method, wherein the data engine is configured to complete the financial transaction according to the one or more rules for establishing selection of the payment method.

In one embodiment, the user interface is configured request user approval of the payment method prior to completion of the financial transaction by the data engine. In one embodiment, the user interface is a touchless user interface configured to provide information to a user primarily through an audio output

Another embodiment of the present disclosure provides a mobile money management system including a data engine configured to wirelessly communicate data concerning a financial transaction with a point-of-sale (POS) terminal located at a place of business, and a user interface configured to enable a user to create a customized budget to establish one or more spending limits for a plurality of spending categories, wherein the user interface presents the user with a series of questions to gather a variety of personal data about the user and reviews establish spending limits with other users of the mobile money management system two established an advised range of spending limits for each of the plurality of spending categories.

In one embodiment, the user interface is further configured to aid a user in creation of a customized budget to establish one or more spending limits. In one embodiment, the user interface is configured to present the user with a series of questions to gather a variety of personal data to establish the one or more spending limits. In one embodiment, the customized budget is established through the use of a decision tree configured to tailor the one or more spending limits to the needs of a specific user. In one embodiment, the data engine is configured to review established spending limits of other users of the mobile money management system to establish an advised range of spending limits for each of a plurality of spending categories. In one embodiment, the one or more spending limits are established for at least one spending category of a plurality of spending categories. In one embodiment, the data engine is configured to establish an initial list of spending categories, and wherein the user interface enables a user to modify the initial list of spending categories. In one embodiment, the data engine is configured to assign a completed financial transaction to at least one spending category based on at least one of the place of business, the purchased product or service, the amount of the completed transaction, the date of the completed transaction, or the payment method associated with the completed transaction. In one embodiment, the user interface is configured to enable a user to reassign a completed financial transaction to a different spending category. In one embodiment, the user interface is configured to present a summary of completed financial transactions relative to the one or more spending limits, wherein the summary graphically displays a difference between a total amount of the completed financial transactions assigned to a first spending category and a spending limit established for the first spending category. In one embodiment, the user interface is configured to provide a user alert or notification that total amount of the completed financial transactions assigned to the first spending category is nearing or exceeding the established spending limit for the first spending category.

In one embodiment, the user interface is configured to enable user to link the mobile money management system with one or more joint financial accounts to enable records and other data concerning financial transactions entered into by at least a first user and the second user to be displayed on the user interface. In one embodiment, the user interface is configured to enable the at least one of the first or second user to flag a particular financial transaction and to at least one of message or send details of the flag financial transaction to the other user. In one embodiment, the user interface is further configured to present purchase related guidance to a user prior to completion of the financial transaction. In one embodiment, the purchase related guidance relates to an established periodic spending limit associated with at least one of a payment method or a spending category. In one embodiment, the purchase related guidance relates to at least one of a consumer review of a product or service, a price comparison of a similar product or service at another place of business, or price comparison of a substitute product or service.

Another embodiment of the present disclosure provides mobile money management system including a data engine configured to wirelessly communicate data concerning a financial transaction with a point-of-sale (POS) terminal located at a place of business, and a user interface configured to enable a first user to monitor financial transactions made by second user, wherein the user interface enables the first user to establish a location-based spending limit for the second user prior to the completion of any financial transactions.

In one embodiment, the user interface configured to enable a first user to monitor pending and completed financial transactions by a second user. In one embodiment, the user interface is configured to present a first user authorization request prior to completion of a financial transaction by the second user. In one embodiment, a first user authorization request is based on a location of the second user. In one embodiment, the user interface is configured to enable the first user to establish a spending limit at an established location prior to completion of a financial transaction by the second user. In one embodiment, the user interface is configured to provide one or more notifications regarding an established spending limit at an established location. In one embodiment, a financial transaction in proximity to the established location at or below the established spending limit does not prompt the user interface to present the first user authorization request prior to completion of the financial transaction by the second user

Another embodiment of the present disclosure provides a mobile money management system, including a data engine configured to wirelessly communicate data concerning a financial transaction with a point-of-sale (POS) terminal located at a place of business, and a user interface configured to provide an advertisement for a good or service of potential interest to a user, wherein the advertisement is prompted by a difference between a total amount of completed financial transactions assigned to a first spending category and one or more spending limits established for the first spending category.

In one embodiment, the user interface is configured to provide an advertisement for a good or service of potential interest. In one embodiment, the advertisement is prompted by a difference between a total amount of completed financial transactions assigned to a first spending category and one or more spending limits established for the first spending category. In one embodiment, the advertisement is prompted by a location of the user. In one embodiment, the advertisement is prompted by a spending history by the user. In one embodiment, the advertisement is prompted by at least one of a sale or discounted price of a user identified product or service of interest. In one embodiment, the advertisement is prompted by at least one of a statistical based algorithm or machine learning algorithm configured to determine a timing of the advertisement, wherein a timing of the advertisement based on an increased likelihood that the user will act upon the advertisement.

In one embodiment, the financial transaction is completed through a decentralized trust force verification process initiated by one or more asymmetric cipher functions. In one embodiment, each of the one or more asymmetric cipher functions rely on a first key and a second key for the user and a first key and a second key for the point-of-sale terminal. In one embodiment, at least one of the first key and the second key for the first user are generated by a Rivest-Shamir-Adleman algorithm. In one embodiment, the first key for the both the user and the point-of-sale terminal are publicly known, and wherein the second key for both the user and the point-of-sale terminal are held in secret respectively by the user and the place of business. In one embodiment, the second key for both the user and the point-of-sale terminal is used to decrypt wirelessly communicated data concerning a financial transaction encrypted by the first key for both the user and the point-of-sale terminal. In one embodiment, data concerning the financial transaction is recorded as a ledger entry in any communal electronic ledger. In one embodiment, the first key and the second key for at least one of the user or the point-of-sale terminal is used create a digital signature concerning a financial transaction, thereby indicating an approval by at least one of the user or the place of business of the financial transaction. In one embodiment, the digital signature is further a function of a ledger entry, such that any change to the ledger entry would invalidate the digital signature. In one embodiment, the digital signature comprises at least 256 bits.

The summary above is not intended to describe each illustrated embodiment or every implementation of the present disclosure. The details of one or more aspects of the disclosure are set forth in the accompanying drawings and the description below. Other features, objects, and advantages of the techniques described in this disclosure will be apparent from the description in the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a schematic view depicting a mobile money management system configured to enable user to conduct and manage financial transactions, including completing sales transactions at a point-of-sale (POS) terminal located a merchant's place of business, transferring money to other individuals, establishing spending limits, and receiving purchase related guidance, among other features, in accordance with an embodiment of the disclosure.

FIG. 1B is a block diagram depicting a portable computing device configured to enable user interaction with the mobile money management system, in accordance with an embodiment of the disclosure.

FIG. 2 is a flowchart illustrating a method of communicating payment information to a POS terminal, as performed by the mobile money management system, in accordance with an embodiment of the disclosure.

FIG. 3 is a block diagram depicting an interaction of the mobile money management system with a POS terminal, in accordance with an embodiment of the disclosure.

FIG. 4A is a diagram illustrating a transaction with the mobile money management system initiated by one or more asymmetric cipher functions, in accordance with an embodiment of the disclosure.

FIG. 4B is a diagram illustrating one or more transactions initiated with the mobile money management system grouped into distinct blocks, thereby creating a chain or sequence of blocks, in accordance with an embodiment of the disclosure.

FIG. 5A is a block diagram depicting a linking of the mobile money management system with one or more financial accounts, in accordance with an embodiment of the disclosure.

FIG. 5B depicts a user interface of the mobile money management system providing a graphical depiction of the total amount transactions assigned to one or more spending categories over a given period of time, in accordance with an embodiment of the disclosure.

FIG. 5C depicts a user interface of the mobile money management system providing an alternate graphical depiction of the total amount transactions assigned to one or more spending categories over a given period of time, in accordance with an embodiment of the disclosure.

FIG. 6 depicts a decision tree configured to enable the mobile money management system to aid a user in creating a customized budget, in accordance with an embodiment of the disclosure.

FIG. 7A depicts a mobile money management system configured to enable a first user to monitor and provide one or more limitations to transactions of a second user, in accordance with an embodiment of the disclosure.

FIG. 7B depicts a mobile money management system configured to determine a location of the user, with one or more limitations to transactions applying to the determined location, in accordance with an embodiment of the disclosure.

FIG. 8 depicts a graphical representation of control data concerning targeted advertisements, in accordance with an embodiment of the disclosure.

FIG. 9A depicts a naïve Bayesian network configured to improve targeted advertising, in accordance with an embodiment of the disclosure.

FIG. 9B depicts an augmented naïve Bayesian network configured to improve targeted advertising, in accordance with an embodiment of the disclosure.

FIG. 9C depicts an inverted augmented naïve Bayesian network configured to improve targeted advertising, in accordance with an embodiment of the disclosure.

FIG. 10A is a network diagram depicting a neural network, in accordance with an embodiment of the disclosure.

FIG. 10B depicts a single neuron within the neural network of FIG. 10A, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

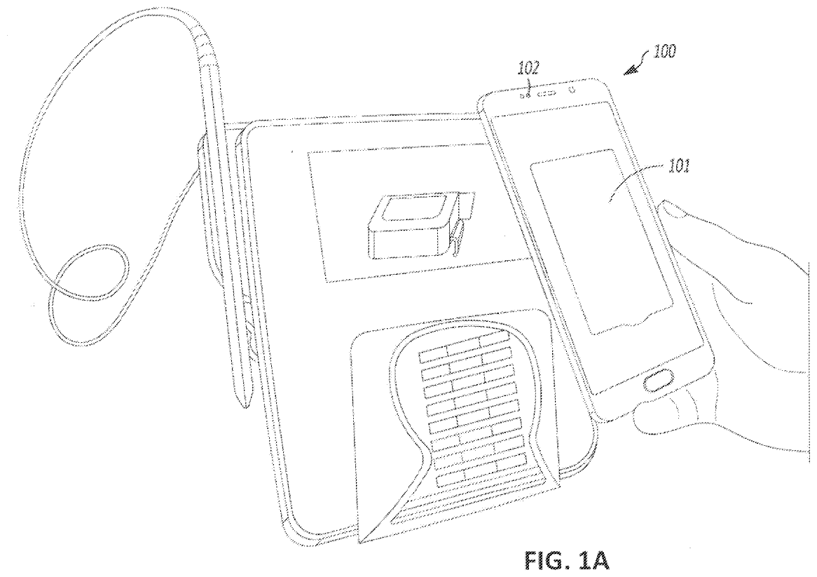

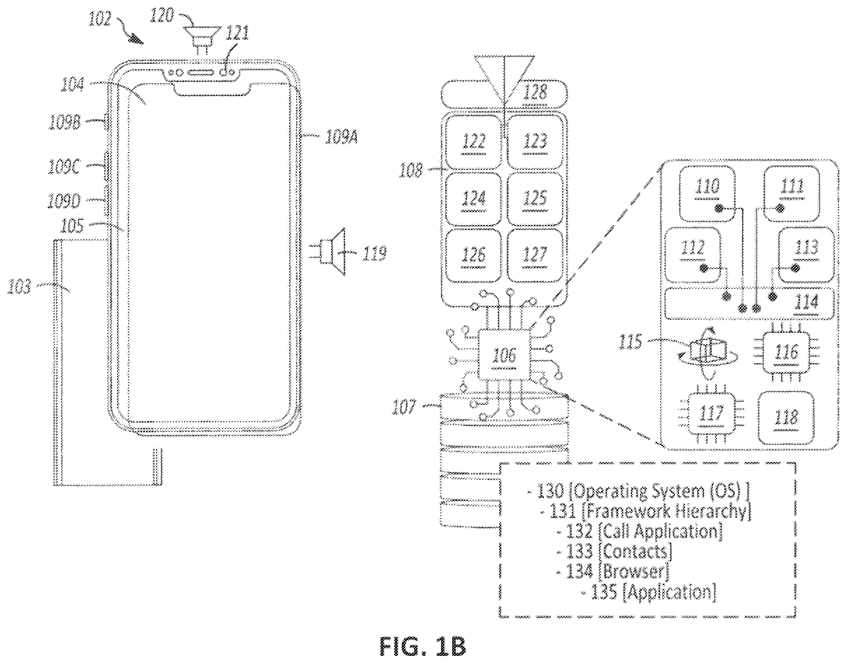

Referring to FIG. 1A, a mobile money management system 100 configured to enable a user to conduct and manage financial transactions, including completing sales transactions at a point-of-sale (POS) terminal located a merchant's place of business, transferring money to other individuals, establishing spending limits, and receiving purchase related guidance, among other features, is depicted in accordance with an embodiment of the disclosure. Mobile money management system 100 comprises a user interface 101 enabling a user to enter or receive information. The user interface can include one or more of a screen, touchscreen, button, smart button, wheel, pad, mouse, trackpad, stylus, electronic pencil, or some other device by which a user can receive information about or provide information to the mobile money management system 100. Although the mobile money management system 100 is depicted as being presented on a cellular telephone, the techniques as described herein are equally applicable to other types of portable computing devices 102, such as personal digital assistants, tablets, watches, bracelets, music players (e.g., MP3, ACC, etc.), FOBs, and the like.

With additional reference to FIG. 1B, a block diagram of a portable computing device 102 configured to enable user interaction with the mobile payment system 100 is depicted in accordance with an embodiment of the disclosure. In some embodiments, the portable computing device 102 can include a power source 103, a display 104, a sensor 105, a controller 106, storage 107, and a communication unit 108.

The display 104 can be a liquid crystal display (LCD), an organic light emitting diode (OLED) display, a plasma display panel (PDP), or the like. In some embodiments, a driving circuit, which can be implemented with an amorphous (a-Si) thin film transistor (TFT), a low temperature polysilicon (LTPS) TFT, an organic TFT (OTFT), or the like, can be included in the display 104. In some embodiments, the display 104 can include a backlight unit.

The sensor 105 can be configured to sense a user's touch on a surface of the display 104. The sensor 105 can be implemented with various types of sensing technology, such as a capacitive touch type sensor configured to sense micro-electricity excited to a user's body using a dielectric coating on a surface of the display 104 to calculate a touch coordinate, a resistive type sensor configured to include an upper and lower electrode plate built into the display 104 to sense current through the upper and lower electrode plates in contact with each other at a touch point to calculate touch coordinate, a piezoelectric type sensor, and the like. Thus, the sensor 105 can sense various types of user touch operations, including touch and hold, touch and drag, tap, double tap, flick, etc.

The controller 106 can control an overall operation of the portable computing device 102 using an operating system (OS) stored in the storage 107. The controller 106 can be configured to sense user input (e.g., via the sensor 106, hardware buttons 109A-D, voice commands, and other gestures) to perform functions corresponding to the user input. The storage 107 stores the OS for driving the device 102, programs, data, and other content. Specifically, the controller 106, in communication with the sensor 105, which can sense touch on a surface of the display 104, can compare a coordinate value of each object displayed on the display 104 with a touch coordinate value of the sensor 105 to determine which object is selected.

The controller 106 can include a random access memory (RAM) 110, a read-only memory (ROM) 111, a central processing unit (CPU) 112, a graphic processing unit (GPU) 113, a bus 114 and the like. The RAM 110, ROM 111, CPU 113 and GPU 113 can be communicatively coupled to one another through the bus 114. The CPU 112 can access the storage 107 to perform boot operations using the OS. A command set for system booting and the like may be stored in the ROM 111. When a turn-on command is input and power is supplied, the CPU 113 can copy the OS stored in the storage 107 to the RAM 110 according to a command stored in the ROM 118 and execute the OS to boot the system. When the booting is complete, the CPU 113 can copy various types of programs stored in the storage 107 to the RAM 110 and execute the programs copied to the RAM 110 to perform various types of operations. Alternatively, when an application is set as a default to run, the CPU 112 can automatically execute the application when the booting is complete. The GPU 113 generates graphical outputs for display on the screen 104. Specifically, the GPU 113 can perform rendering on the screen 104 based on the running program and sensed user input.

In some embodiments, the controller 106 can sense a rotation state, such that if the device 102 is rotated, a graphical output displayed on the screen 104 can be rotated to be considered generally upright relative to a gravitational frame of reference. For example, in some embodiments, the controller 106 can include a motion sensor 115 configured to sense a motion, such as a rotation state of the device 102 using a gyro sensor, geomagnetic sensor, an acceleration sensor, and the like. In addition to rotation, the controller 106 can perform various control operations according to a motion sensed by the motion sensor 115.

In addition to the CPU 112, the device 102 can include a number of other processors and units, including but not limited to an audio processor 116, a video processor 117 and a capturing unit 118. The audio processor 116 can be configured to perform processing on audio data, such as decoding, amplification, noise filtering, and the like. The video processor 117 can be configured to perform processing on video data, such as decoding, scaling, noise filtering, frame rate conversion, resolution conversion, and the like. The audio processor 116 and video processor 117 can be driven when a program for reproducing contents stored in the storage 107 or received from an external source are executed. The display 104 can display an image frame generated in the video processor 117, as well as various screens on which the GPU 113 can perform rendering. A speaker 119 can output audio data generated by the audio processor 116. A microphone 120 can be configured to receive the user's voice or other sound for conversion into audio data. In some embodiments, the controller 106 can use the audio data received by the microphone 120 as sensed user input to perform certain functions. The capturing unit 118 can be configured to capture data via a camera 121.

The communication unit 108 enables communications between the device 102 and an external apparatus (e.g., a local area network, a Wi-Fi network, a POS system, another portable computing device, etc.). The communication unit 108 can be configured to enable a variety of communication methods, including wireless local area network (LAN), wireless fidelity (Wi-Fi), Bluetooth, Zigbee, near field communication (NFC), magnetic secure transmission (MST) and the like. The communication unit 112 can include a wireless communication chip 122, Wi-Fi chip 123, a Bluetooth chip 124, and NFC chip 125, a GPS chip 126, a DMB receiver 127, and the like. The wireless communication chip 126 can denote a chip configured to perform communications according to various communication standards, such as Institute of Electrical and Electronic Engineers (IEEE), Zigbee, third generation (3G), fourth generation (4G), fifth generation (5G), and long term evolution (LTE). The GPS chip 126 can be configured to receive a GPS signal from a GPS satellite and calculated current location of the device 102. The DMB receiver 127 is configured to receive and process a DMB signal. The communication unit 108 can include at least one among the above-described chips or chips according to other communication standards and perform communication with various external apparatuses using the chips. In some embodiments, the communication unit 108 can be in communication with an optional encoder/decoder 128 to at least one of aid in compression of wirelessly communicated information or impede the readability of the information intercepted by third parties.

The portable computing device 102 can further include one or more hardware buttons 109A-D. In some embodiments, the one or more hardware buttons 109A-D can include various types of buttons provided on a body of the device 102, such as a home button, pushbutton, touch button, wheel button, or the like.

In some embodiments, the device 102 may default to a locked state or condition to disable the display 104 when the user does not interact with the device 102 for a certain period of time. Pressing a hardware button 109A-D provided on the body of the device 102 can cause the display unit to display a lock screen. Preset gesture information to unlock the lock screen can be included in the data stored in the storage 107. When a user's touch is sensed by the sensor 105, the controller 106 determines whether or not the user touch operation matches the gesture information stored in the storage 107. Upon successful performance of an unlock operation on the lock screen, the display 104 can be unlocked, and either a home screen or one or more screens related to an application can be displayed. For example, if it is determined that the user touch operation matches the gesture information to open a specific application (e.g., a mobile money management application configured to enable a user to conduct and manage financial transactions, etc.), the controller 106 enables the display 104, and executes the application corresponding to the user touch operation, to display one or more screens related to the application. In some embodiments, the controller 106 or hardware buttons 109A-D can be configured to unlock the device 102 and display one or more screens related to an application, even when the display 104 is locked or not fully enabled.

The controller 106 and other processors can comprise or include various modules or engines, each of which is constructed, programmed, configured, or otherwise adapted to autonomously carry out a function or set of functions. The term “engine” as used herein is defined as a real-world device, component, or arrangement of components implemented using hardware or as a combination of hardware and software, such as by a microprocessor system and a set of program instructions that adapt the engine to implement a particular functionality, which (while being executed) transform the microprocessor system into a special-purpose device.

An engine can also be implemented as a combination of hardware and software, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In some embodiments, the controller 106, storage 107 and other processors may include various types of software, such as an OS 130, a framework hierarchy 131, a call application 132, contacts 133, and a browser 134, as well as variety of other programs and applications, such as a mobile money management application 135. The OS 130 can provide a set of commands to be executed by the controller 106 and other processors to manage basic functions of the device via various drivers and modules. For example, the OS 130 can drive a display driver configured to drive the display 104, a communication driver configured to enable the communication unit 108 to transmit/receive signals, a camera driver configured to drive the capturing unit 118, an audio driver configured to drive the audio processor 116, modules of a power manager, and the like to control the overall operation of the device 102.

The framework hierarchy 131 can establish an upper hierarchy within the OS 130. The framework hierarchy 131 performs functions for connecting respective application programs (e.g., the mobile money management application 135) of an application hierarchy to the OS hierarchy. For example, the framework hierarchy 131 can include a local manager, a notification manager, a frame buffer configured to display an image on the display 104, and the like. The application hierarchy can be configured to implement functions of the programs and applications loaded on the device 102 in the upper hierarchy of the framework hierarchy 131.

The mobile money management system 100 and associated methods as described herein can be implemented via a complex set of rules or logic (occasionally referred to herein as “functional modules”) defining the mobile money management application 135 stored on non-transitory computer recordable media. The functional modules can include, for example, Java applets (Java card applications that execute under the control of a Java Card Virtual Machine) and Java Classes (definitions for segments of code that may contain both data and functions that may operate on that data). The non-transitory computer-recordable medium is not a medium configured to temporarily store data such as a register, a cache, a memory, and the like but an apparatus-readable medium configured to semi-permanently store data. Specifically, the applications or programs as described herein may be stored and provided in the non-transitory computer-recordable medium such as a compact disc (CD), a digital versatile disc (DVD), a hard disc (HD), a blu-ray disc, a USB, a memory card, a read only memory (ROM), and the like. In some embodiments, the set of functional modules can be updated or altered without impacting the ability of the application functional modules to implement the desired functions and operations.

In some embodiments, functional modules defining the mobile money management application 135 are configured to manage and maintain the security of one or more of the user's payment accounts and associated payment transaction information, and can be hosted by a secure element (SE) implementation based on Java Card and Global Platform specifications. In one embodiment, the functional modules comply with the EMV contactless communications protocol specification 2.0 and are implemented as a Java Card applet (or applets) that run on the SE. For example, in one embodiment, the functional modules can be stored either within a secure element (SE) or in another data storage element of the device 102. In some embodiments, the functional modules can be installed directly on the SE, while a user interface application used to access the functionality of the components of the functional modules can be installed outside of the SE, and in another data storage element of the device 102. In one embodiment, the functional modules provide a set of Application Protocol Data Unit interfaces (APDU), which are data packets exchanged between an applet and a host application that is executing the applet for interaction with the mobile money management application 135. Note that EMV is a standard for the interoperation of IC cards (“Chip cards”) and IC capable POS terminals and ATMs, and is used for authenticating credit and debit card payments, where EMV is an acronym for Europay, MasterCard, and Visa, the originators of the standard. In addition to storage and implementation by the portable computing device 102 (e.g., in communication with various other external devices and apparatuses) the non-transitory computer readable media may be at least partially stored, hosted or executed on a remote apparatus or server.

In one embodiment, the mobile money management system 100 is configured to communicate with a POS terminal or one or more servers (e.g., a retail environment server, portal site server, cloud server, server of a service provider providing POS systems, payment gateway (PG) server, and the like) to facilitate the payment of goods or services. For example, in one embodiment, when a user executes a payment command, the communication unit 108 of the device 102 transmits information regarding the payment command to the POS terminal.

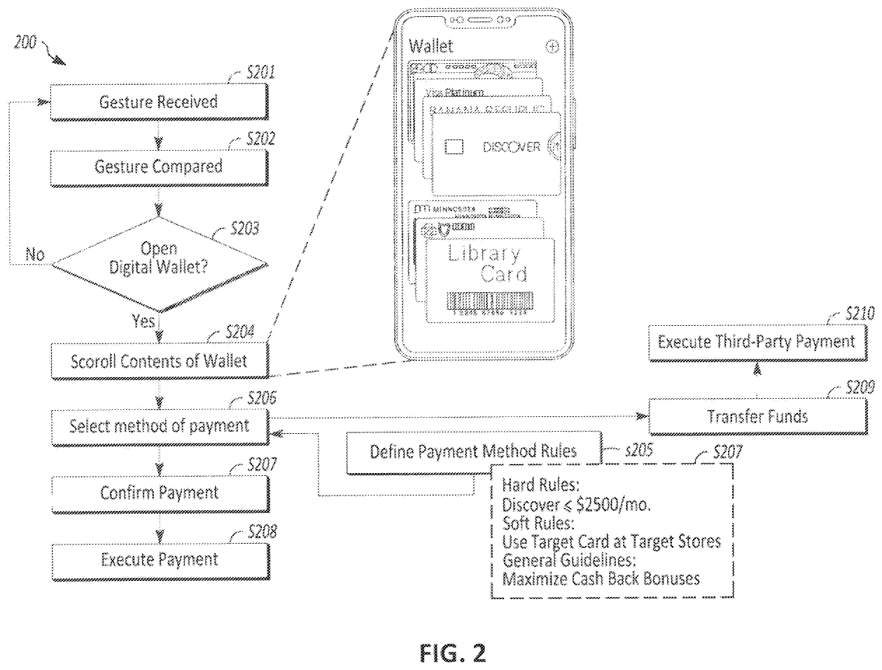

With additional reference to FIG. 2, a flowchart illustrating a method 200 of communicating payment information to a POS terminal, as performed by the mobile money management system 100, is depicted in accordance with an embodiment of the disclosure. At S201, a gesture or combination of gestures made by the user (e.g., touch sequence, pin number, fingerprint, voice command, facial scan, iris scan, or the like) is received by the device 102. At S202, the received gesture or gestures are compared with the gesture information stored in the storage 107.

At S203, if it is determined that received gesture information matches the stored gesture information the controller 106 can enable the display 104 to execute the money manager application 135, so as to display one or more screens related to the application 135. For example, in one embodiment, the display 104 can present the user with a representation of the contents of a typical wallet (occasionally referred to herein as the “digital wallet”). The contents of the digital wallet can be defined by the user, and can include such items as a representation of a driver's license and other forms of identification, membership cards, credit cards, debit cards, gift cards, cash, and the like. Alternatively, if it is determined that the received gesture information does not match the stored gesture information, the display 104 can remain in a locked configuration.

At S204, the user can scroll through the contents of their digital wallet, for example, to select a form of payment or other item within the digital wallet. In some embodiments, selection of an item within the digital wallet can enable the user to make the representation of the item larger or smaller, and to virtually flip the item over to view both a front and a back of the item.

In some embodiments, the mobile money management system 100 can recommend payment according to a particular method (e.g., credit card, debit card, cash or the like) based on a defined set of rules regarding payment prioritization. The rules, which can be defined at S205, can include credit limits (e.g., do not exceed $2500 per calendar month when paying with the Discover card), cash back bonuses, credited miles/points, or the like (e.g., use the user Discover card when available to obtain 5% cash back), discounts (e.g., use the Banana Republic card at all Gap outlets to obtain maximum discount), and the like. In some embodiments, the rules can be configured to automatically prioritize certain payment methods with certain categories of spending or geographic locations (e.g., whenever possible use the Chase MasterCard at gas stations, whenever possible use the Target card at Target® brand stores, etc.). In some embodiments, the rules can distinguish and prioritize between “hard rules” (e.g., rules that should never be violated), “soft rules” (e.g., rules that generally benefit the user, but can be violated if overridden by a temporary user preference or superseded by a hard rule), and “general guidelines” (e.g., general preferences established by the user).

At S206, a particular payment method to purchase a good or service can be selected, either automatically by the mobile money management system 100, or manually by the user. If a credit or debit card is selected at S206, the user can optionally be presented with a request to confirm payment at S204, which can in turn be sent to a POS terminal. If payment is confirmed (or the step of confirmation is optionally omitted), the payment can be executed at S208.

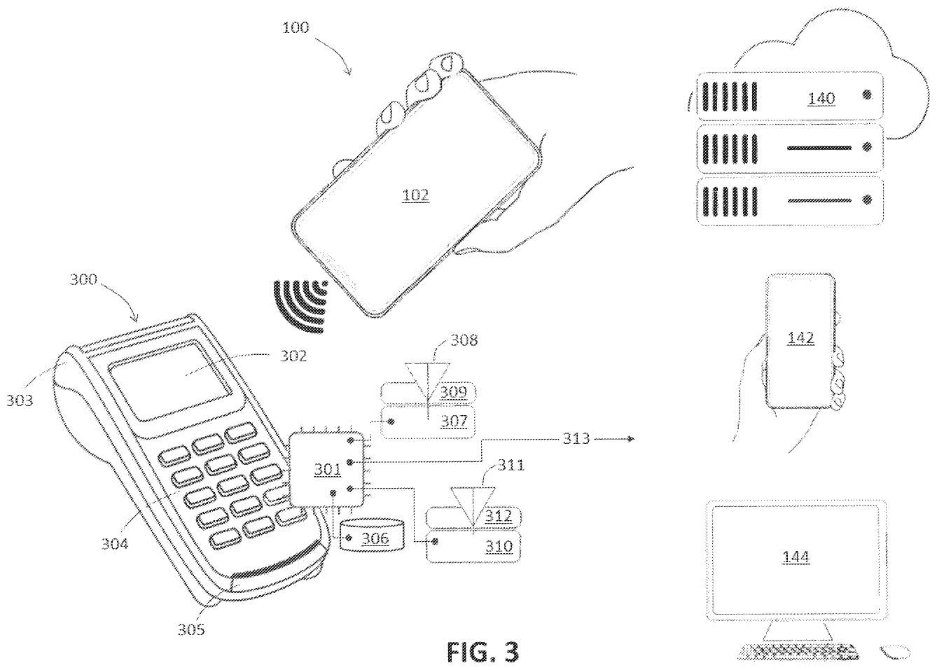

With additional reference to FIG. 3, a POS terminal 300 is depicted in accordance with an embodiment of the disclosure. In embodiments, the POS terminal 300 can be virtually any type of point-of-sale terminal, which in some embodiments can include a card reader or similar type of device capable of receiving identification and payment authorization information from the mobile payment system 100. In some transactions, the POS terminal 300 transmits at least a portion of the payment information to the merchant's processing system or directly to a bank or institution that manages the merchant's account. The payment information can then be provided to a payment processing network in communication with data processors which process the transaction data to determine if the transaction should be authorized, and to assist in the clearance and account settlement functions for the transaction. In other embodiments, the authorization can be done locally, without the need to access remote databases for the purpose of user authentication and record keeping at the time of the transaction.

In some embodiments, the POS terminal 300 can include a processor 301, which can be in communication with a display 302, a printer 303, a first input (e.g., keypad input) 304, an optional second input (e.g., scanner or barcode reader) 305, and an optional memory 306. To enable receipt of wireless communications from the portable computing device 102, the processor 301 can further be in communication with a transmitter/receiver 307 and antenna 308.

In some embodiments, the POS terminal 300 can include an optional encoder/decoder 309 for the encoding and decoding of wireless communications between the POS terminal 300 and the portable computing device 102. For example, the encoder/decoder 309 can be a dual tone multiple frequency (DTMF) encoder/decoder; however, various types of data transmission techniques may be used, and various forms of encryption and data for security purposes may be employed, in addition to, or in lieu of DTMF encoding and decoding. For example, in some embodiments, the encoder/decoder 309 can employ at least one of symmetric encryption algorithms (e.g., data encryption standard (DES), advanced encryption standard (AES), etc.) or an asymmetric encryption methodology. In some embodiments, the POS terminal 300 can include an identification device, such as a customer identification device (CID), configured to generate a signal for exciting a transponder within the portable computing device 102 to transmit its coded data.

To enable communications with a communications network, the processor 301 can be in communication with a transmitter/receiver 310 and antenna 311. In embodiments, the communications network can be configured to facilitate communications with a payment processing network, merchant's processing system, bank, institution, and the like. Like wireless communication between the POS terminal 300 and the portable computing device 102, an encoder/decoder 312 can optionally be employed for improved security. In addition to, or as an alternative to wireless communications, the processor 301 can have a wired connection 313 to the communications network. In some embodiments, the POS terminal 300 can be a “dummy terminal,” such that the various input, output, and display devices merely interface with a communications network before connecting with remote servers and processing units. In such a system, typically a plurality of POS terminals 300 are connected in an on-line manner to servers and processing units, such that the processing capability at the actual location of the terminal is minimal or non-existent.

As further depicted in FIG. 3, in addition to communicating with the POS terminal 300, the portable computing device 102 can communicate details regarding the transaction to one or more remotely located servers 140, where information regarding the transaction can be maintained in a cloud for retrieval by other devices 142, 144. For example, in one embodiment, information regarding the transaction can be transmitted to one or more additional portable computing devices 142, thereby notifying one or more other users of the mobile money management system 100 that the transaction has occurred. In another example, transaction information collected in the server 140 can be viewed by other computing devices (e.g., a desktop computer 144), thereby enabling analysis of the transactions (e.g., producing monthly reports, tracking spending, and the like). Other embodiments of mobile money management system 100 are also contemplated.

With reference again to FIG. 2, if cash is selected at S206 (as opposed to a credit or debit card), the user can optionally be presented with a request to confirm payment at S207, and the payment can be executed at S208, thereby sending payment information to the POS terminal 300. At S208, and electronic receipt or equivalent thereof can be recorded in a digital ledger (as described in further detail below) for an accounting of the transaction. According to such cash transactions, in some embodiments, the actual payment an accounting ledger functions can be similar to that of smart cards or chips, where the amount of the purchase is debited from the user's account and credited (or otherwise transferred) to the merchant's account.

In addition to using cash within the electronic wallet to purchase goods and services, at S209, a user can use the mobile money management system 100 to transfer funds to or from the electronic wallet from a bank or other institution. Accordingly, in some embodiments, the system 100 can be used to withdraw cash (in a digital form) from an ATM, deposit cash in the electronic wallet into a bank account, and the like. At S210, a user can use the system 100 to transfer funds to a third-party, for example, to enable the user to split a bill with a friend by sending or receiving partial payment of the bill to or from the friend's portable computing device. Other types of transfers are also contemplated. For example, in some embodiments, the mobile money management system 100 can be used to complete international money transfers or exchanges, or other exchanges of currency, including one or more crypto-currencies (e.g., Bitcoin, Ethereum, Ripple, Litecoin, etc.).

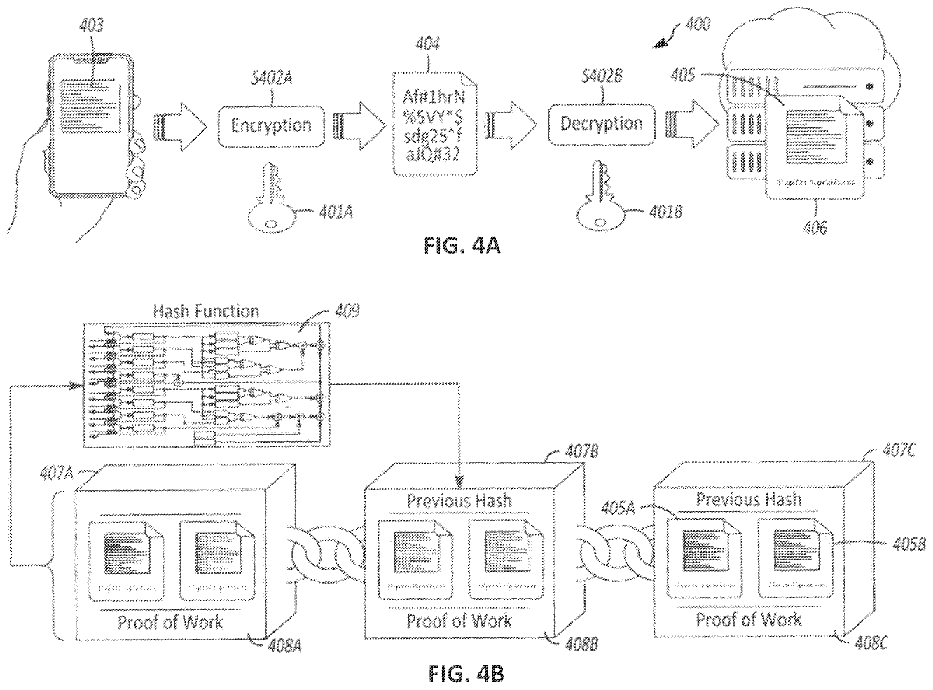

In some embodiments, the various transactions as described herein can be executed and recorded in a communal electronic ledger with the aid of a decentralized trustless verification process (e.g., without the involvement of a bank or other financial institution). For example, with reference to FIG. 4A, in one embodiment, various transactions (e.g., between the user and a vendor, merchant or other party, between distinct accounts held by the user, or the like) can be initiated by one or more asymmetric cipher functions 400.

The asymmetric cipher function 400 can rely on a pair of keys 401A/B for each user. For example, in one embodiment, the pair of keys 401A/B can be generated with a Rivest-Shamir-Adleman (RSA) algorithm, although the use of other algorithms is also contemplated. The pair of keys 401A/B, can include a first key 401A (sometimes referred to as a “public key”), which is publicly known, at S402A can be used to encrypt an unencrypted message 403 sent to a particular user into an encrypted message 404. A second key 401B (sometimes referred to as a “secret key” or “private key”), which is held in secret by the user, at S402B can be used to decrypt messages 404 sent to the user that were encrypted by the paired public key 401A into a decrypted message 405. Accordingly, the first key 401A can be used to lock a message 403 for a particular user (resulting in locked message 404), while the second key 401B can be used to unlock the message 404 (resulting in an unlocked message 405).

As a further layer of security, the key pair 401A/B can be used to create a digital signature accompanying the details of any transaction. That is, where a user wishes to send another party a sum of money, the user may create an entry in the communal electronic ledger, having the effect of debiting the sum of money from their account and crediting that same sum of money to the other party's account. In doing so, the user can look up the public key 401A for the other party to encrypt the details of the transaction for transmission to the other party. Upon receipt, the other party can apply their secret key 401B to decrypt the details of the transaction, and add a digital signature 406 indicating their approval of the transaction. To inhibit later alteration of the ledger entry, in some embodiments, the digital signature 406 (e.g., comprising 256 bits) can be a function of both the private key 401B and the ledger entry 405 itself, such that any change to the ledger entry 405 would invalidate the digital signature 406. Moreover, because the digital signature 406 is specific to the details of each ledger entry 405, nefarious users may be discouraged from copying the digital signature 406 for later use in a forgery.

The electronically signed transaction 405 can then be added to a communal electronic ledger. In some embodiments, multiple copies of the communal electronic ledger can be maintained, with additional transactions periodically added to the ledger. For example, with reference to FIG. 4B, in some embodiments, the transactions 405A-B can be grouped into distinct blocks 407C, each of which can be sequentially added to a previous block 407B, thereby creating a chain of blocks 407A-C (sometimes referred to as “block chain”). To inhibit alteration of the transactions, each of the blocks 407A-C can both referred to the block immediately ahead of it in the chain (e.g., block 407C refers to block 407B), and include a unique number 408A-C (sometimes referred to as “proof of work”), such that a cryptographic hash function of the block 408A (e.g., including a hash or digest of the previous block 410, the contents of the current block, and a unique number) produces a hash or digest with a particular format (e.g., a 256-bit integer beginning with a specified number of zeros, etc.). For example, in one embodiment, a SHA256 cryptographic hash function 409 can be employed to produce the hash or digest.

A block 407C is only valid if it includes a proof of work 408C (e.g., the determination of the unique number to produce a hash or digest with a particular format). Any change to a block 407C, or any changes in the order of the blocks 407A-C within the chain, would invalidate the proof of work 408A-C downstream of the change. The proof of work 408A-C can be completed by a third-party (e.g., an institution supporting the mobile money management system software, etc.), who in some embodiments, can be incentivized for their efforts, sometimes referred to as a “block reward”). For example, in some embodiments, the creator of block entries can be rewarded with a transaction fee for all of the transfers occurring within the block; although the use of other incentives for block creation also contemplated.

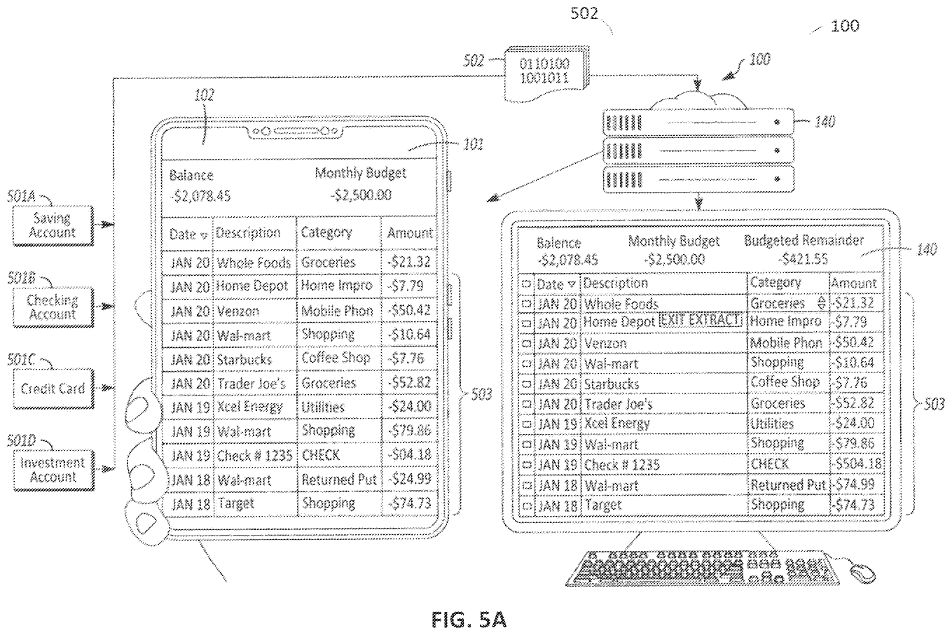

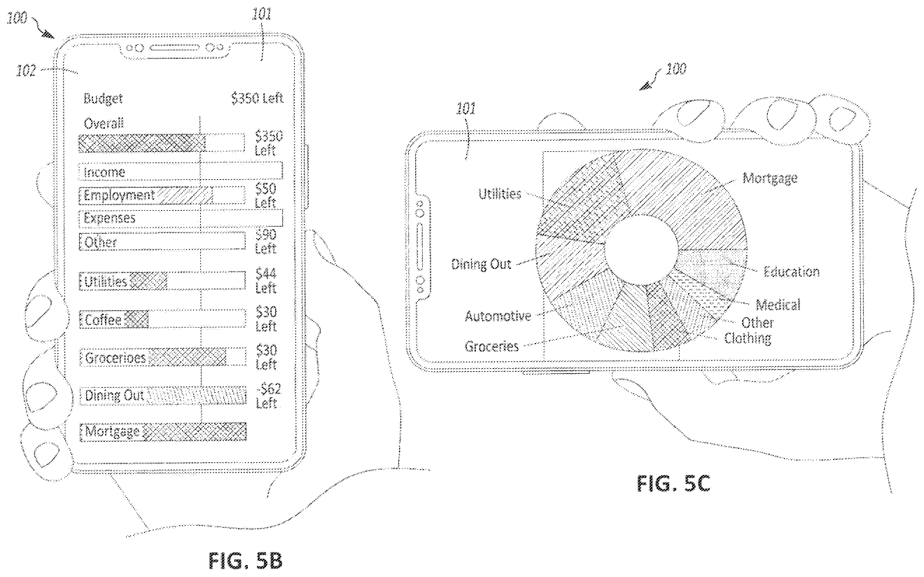

In some embodiments, the mobile money management system 100 can include a budgeting feature enabling a user to view and categorize their financial transactions, set various spending limits, and track their progress over time. For example, with reference to FIG. 5A, in some embodiments, a user can link the mobile money management system 100 with their financial accounts 501A-D (e.g., savings account, checking account, credit accounts, investment accounts, etc.), thereby enabling records or other data concerning the user's financial transactions 502 to be electronically transferred to the mobile money management system 100. For example, in some embodiments, the mobile money management system 100 can query the various linked financial accounts 501A-D from time to time to pull data 502 concerning financial transactions 503 into the mobile money management system 100 (e.g., via server 140, device 102, or the like), for review and analysis by the user.

Thereafter, a user can scroll through a listing of the financial transactions 503 pulled from the various accounts, for example via user interface 101 of portable computing device 102. For ease of use, the financial transactions 503 can be sorted or filtered (e.g., by financial account, date, description, category, amount, etc.), to enable a user to locate particular transactions of interest or to view a subset of the total financial transaction history. In the case of joint or business accounts, the mobile money management system 100 can pull financial transactions entered into by multiple parties for viewing and manipulation by the user. For example, in one embodiment, the user can flag a particular transaction, with the ability to message or send details of the transaction (e.g., date, description, amount, etc.) to a joint user to verify or inquire further about the transaction.

As an aid in analyzing and reviewing the financial transactions, in some embodiments, the mobile money management system 100 can enable the user to establish a number of categories (e.g., income, bills, utilities, mortgage/rent, food & dining, childcare, auto/transport, entertainment, miscellaneous, etc.), thereby enabling the financial transactions to be assigned or designated as belonging to a particular category. For example, the mobile money management system 100 may generate or otherwise provide an initial list of categories, which can later be customized by the user (e.g., categories can be added or deleted from the initial list).

Once the list of categories has been established, spending limits and other budgeting constraints and expectations can be associated with the various categories. For example, the category of food & dining may be assigned a spending limit of $200 per month, while the auto/transport category may be associated with an expectation that transactions falling into this category will amount to approximately $500 per quarter. Accordingly, the budgeting constraints, expectations and associated timelines can be tailored to meet the user's desires.

To ease in management of the volume of transaction data 502, in some embodiments, the mobile money management system 100 can automatically assign a category to a transaction based on at least one of the account 501A-D associated with the transaction, the date, the description, or the amount of the transaction. In some embodiments, the user can opt to manually categorize at least a portion of the transactions. A user can re-categorize transactions as desired. In some embodiments, certain budgeting features associated with the mobile money management system 100 can be accessible by multiple portable computing devices 102, as well as stationary devices (e.g., desktop computers 144, etc.), for example by loading an application onto the device and providing login credentials to gain access to the budgeting features, or by accessing the budgeting features through a secure web portal. Further in some embodiments, various reports relating to the transactions can be printed or exported by the mobile money management system 100.

As depicted in FIGS. 5B & 5C, the mobile money management system 100 can provide a graphical depiction (e.g., via user interface 101) of the total amount of transactions assigned to any category over a given period of time, potentially for comparison to the budgeting constraints and expectations associated with a category. For example, as the transactions associated with food & dining approaches the $200 monthly limit, the graphical depiction may change color (e.g., change from green to yellow to red, etc.), and one or more notifications may be sent to the user (or joint users), alerting them that the total of the transactions in a particular category are nearing, at or exceeding a defined spending limit. Although the use of a series of graphical bars is depicted, other graphical representations are also contemplated.

In some embodiments, a timeline subdivided into units of time can be provided to enable a user to scroll through graphical representations of transactions within different time periods (e.g., previous months, etc.). Selecting any unit of time along the timeline can generate a comparison of the transactions that occurred within that unit of time with the budgeting constraints and expectations associated with categories to which the transactions are assigned. Selecting or highlighting any one of the categories can generate a tabular list of the transactions associated with that category during the associated unit of time.

In addition to graphical outputs, in some embodiments, the user interface 101 can be a touchless user interface configured to provide information to the user primarily through an audio output. Accordingly, in some embodiments, the user interface 101 can be configured to interact with the user (e.g., via voice commands) to provide feedback and guidance regarding past and potential future purchases, as well as providing an overview of the user's budgeting constraints and expectations over a given unit of time.

In some embodiments, the mobile money management system 100 can assist a user in the creation of a budget (e.g., establishing categories, adding spending limits and other budgeting constraints and expectations, etc.). In its most basic form, the mobile money management system 100 can provide a user with a generic, one-size-fits-all budget, which the user can then modify according to their desires. In other embodiments, the mobile money management system 100 may ask the user a series of questions, apply various statistical tools, or use various algorithms or forms of machine learning to provide a user with a more tailored budget.

For example, in one embodiment, the mobile money management system 100 may present the user with a questionnaire to gather a variety of personal data (e.g., age, city and state of residence, sex, married/single, children, expected income, etc.). The system 100 may then review actual budgets of similarly situated users, with an emphasis on more experienced users that have met or exceeded their financial goals. With all personal information scrubbed from the user data to protect privacy, the actual budgets from the group of similarly situated users can be combined or averaged to create a user specific budget including all appropriate categories with average spending limits (e.g., based on a percentage of their expected income), including a standard deviation for each category indicating the potential range of spending limits for each category of interest. Similar information can be gathered and analyzed to assist users in paying down debt.

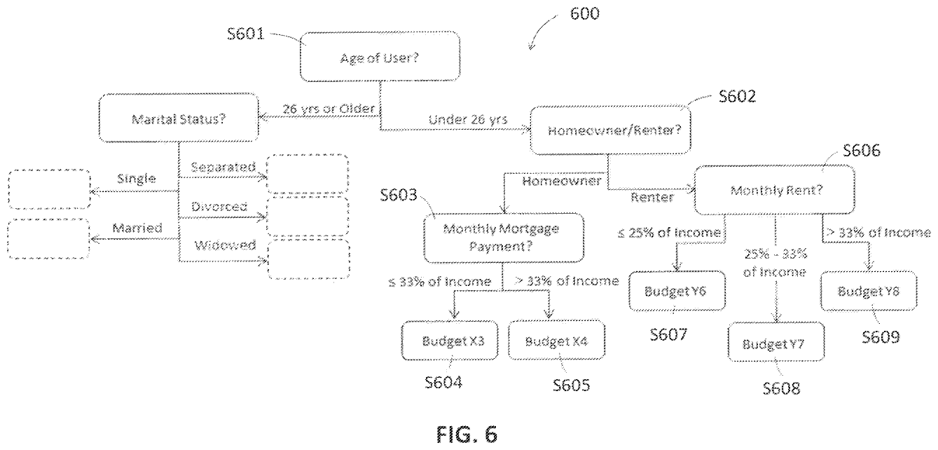

In one embodiment, the system 100 can use decision tree analysis to provide a user with a more tailored budget. For example, with reference to FIG. 6, the decision tree 600 can modeled as a flowchart-like structure where a convergence of paths is avoided. As depicted, the decision tree 600 can set out queries, with a path through the tree 600 defined by answers to the queries. For example, at S601, the mobile money management system 100 can ask the user's birthdate. If the user is under 26 years of age, at S602, system 100 can ask whether the user is a homeowner or renter. If the user indicates that they are a homeowner, at S603, the system 100 can ask how much how much is due each month for their mortgage. If their mortgage payment is less than or equal to 33% of their income, at S604, budget X3 can be applied. Conversely, if their mortgage payment is greater than 33% of their income, at S605, budget X4 can be applied.

According to an alternative path, if the user indicates that they are a renter, at S606, the system 100 can inquire about their monthly rent payment. If their rent is less than or equal to 25% of their income, at S607, budget Y6 can be applied. If their rent is between 25-33% of their income, at S608, budget Y7 can be applied. If the rent is greater than 33% of their income, at S609, budget Y8 can be applied. It should be noted that decision tree 600 merely represents one example algorithm for aid in creating a tailored budget; the use of alternative questions and flow paths is also contemplated.

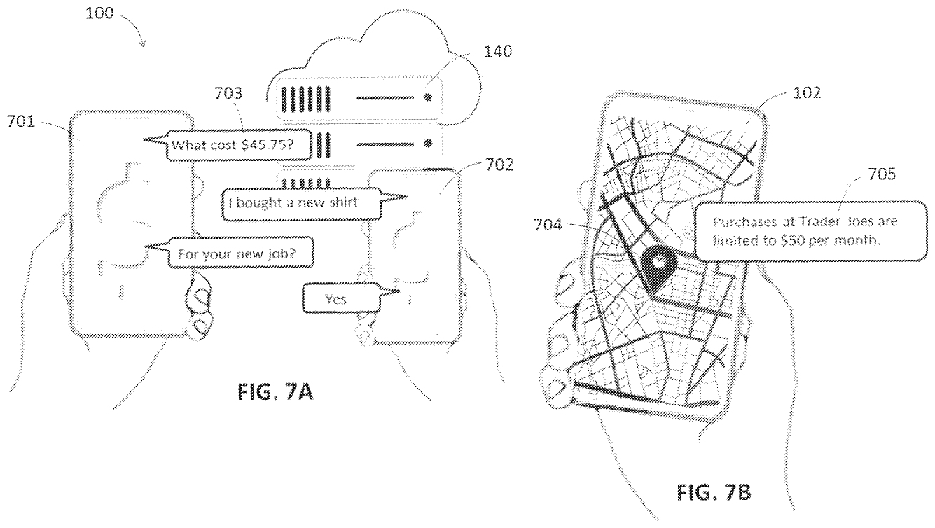

In some embodiments, the mobile money management system 100 can be configured with controls, enabling a first user (e.g., a parent) to monitor and at least partially control financial transactions permitted by a second user (e.g., a child or other dependent). For example, with reference to FIG. 7A, in one embodiment, the mobile money management system 100 can enable a first user 701 to monitor transactions by second, joint user 702 with the ability to message or otherwise inquire about a particular transaction which has occurred or is about to occur (e.g., where the second user 702 requests authorization from the first user 701).

As depicted, in some embodiments, a record of the messages 703 can be saved by in the cloud or system server 140, thereby preserving a history of any comments or dialogue associated with a particular transaction. In other embodiments, the messages 703 can be stored locally on the portable computing devices 102. In some embodiments, the messaging can include an audio or visual component, thereby enabling the respective users 701, 702 to speak to one another (e.g., in real time or via a recorded message) and to visually see one another or the product to be purchased (e.g., via video conferencing, photograph, or the like).

In some embodiments, the mobile money management system 100 can enable the first user 701 to set one or more spending limits or other constraints for the second user 702, thereby restricting an ability of the second user 702 to purchase items or make other financial transactions outside of the spending limits or other constraints. For example, with additional reference to FIG. 7B, the portable computing device 102 can determine a location 704 of the user (e.g., via GPS, cellular network triangulation, or the like). Based on the location 704, the system 100 can provide one or more notifications 705 regarding a spending budget or other financial constraints pertaining to the location. For example, if it is determined by the system 100 that the user is likely at retail environment falling within a particular category (e.g., a grocery store, etc.), the system 100 can provide a notification 705 informing the user of the budget limit for the particular category or the specific retail environment. Further, the system 100 can inform the user of a remaining amount available for spending in the particular category or at the specific retail environment for a given unit of time.

In some embodiments, the mobile money management system 100 can be set up to require approval by the first user 701 prior to specific purchases made by the second user 702. For example, in some embodiments, approval requirements can be tied to the location 704 of the second user, such that approval of the first user 701 is required at certain locations (e.g., outside of a defined boundary, at retail or service environments falling into certain categories, etc.), while use of the system 100 by the second user 702 at other locations does not require approval.

In some embodiments, approval authority can be designated to a third-party (e.g., a friend or other party who may not have access to the financial accounts to which the system 100 is tied). For example, with the system 100 able to identify a user's location, a user with a recognized vice or addiction may establish spending limits (e.g., at a casino), or may require third-party approval prior to making purchases (e.g., at a bar or liquor store). Other uses of the parental and third-party controls are also contemplated.

In some embodiments, the mobile money management system 100 can provide advertisements for goods and services of potential interest to a user through the user interface 101. The advertisements can be targeted, for example, based on one or more statistical tools, algorithms, various forms of machine learning, or a combination thereof. In some embodiments, advertisements can be presented to a user based on an increased likelihood or probability that the user will act upon the advertisement (e.g., purchase the advertised goods or services, place the goods or services on a wish list, etc.).

For example, in some embodiments, the mobile money management system 100 can use Bayes theorem as an aid in determining what advertisements to present to a user, as well as a timing of the advertisements, based on other criteria, evidence or variables. Specifically, Bayes theorem can be useful in identifying the conditional probability associated with an advertisement (e.g., the probability that the advertisement will result in a sale of the advertised goods or services), given that some other event has already occurred or is presently occurring.

For illustration, a restaurant may speculate that an advertisement directed at a particular user may be more effective if it has been more than 30 days since the last time that the user visited the restaurant based on speculations about a particular customer's dining habits. Bayes theorem can be used to quantify this premise or speculation by identifying the conditional probability that the advertisement will be acted upon, if it is been more than 30 days since the last time the user ate at the restaurant. In computing the conditional probability, a record of past events or transactions (sometimes referred to as “control data”) can be analyzed. The control data can be specific to one user, or can be gathered from a larger population of users for later application to a specific user. For example, the control data can be gathered in part from a specific user transaction history of the mobile money management system 100, or from a larger population of users of the mobile money management system 100.

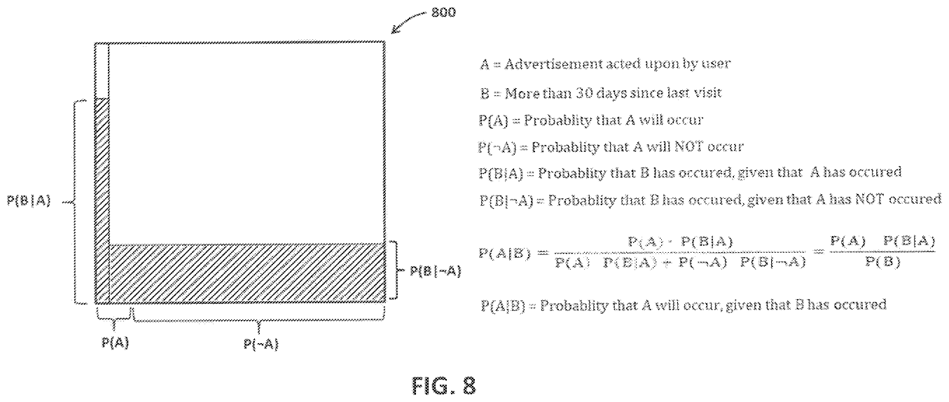

With reference to FIG. 8, a graphical representation of control data 800 concerning advertisements for a particular restaurant presented to potential customers is depicted in accordance with an embodiment of the disclosure. From the control data 800, the mobile money management system 100 can determine what portion of the advertisements resulted in the customer eating at the restaurant within the next day or two, regardless of how often the customer has visited the restaurant. In this particular illustration, control data 800 representing a sampling of 1000 advertisements is used. The total sampling of advertisements can be divided into two portions, represented as P(A), the probability that the advertisement is positively acted upon, before considering other events (sometimes referred to as the “prior”), and P(¬A), the probability that the advertisement is not acted upon, before considering other events.

In this illustration, it is found that 50 out of 1000 advertisements were successful (i.e., P(A)=0.05), before other evidence was considered. In other words, regardless of whether the user ate at the restaurant within the last 30 days, 5% of the advertisements were successful. Conversely, again without considering the frequency of user visits, 950 out of 1000 advertisements were not successful, in the sense that they did not directly result in the customer visiting the restaurant within two days of receiving the advertisement (i.e., P(¬A)=0.95).

Additionally, the control data is examined to determine the probability of finding that it has been more than 30 days since the user visited the restaurant after an advertisement was successfully acted upon, which can be represented as P(B|A) (sometimes referred to as the “likelihood”). The data is also examined to determine P(B|¬A), representing times where it is been more than 30 days since the user visited the restaurant, when an advertisement was not successful. In this illustration, it is found that in 42 of the 50 successful advertisements, it had been more than 30 days since the user visited the restaurant (i.e., P(B|A)=0.84). Conversely, it was found that in 228 of the 950 unsuccessful advertisements, it had also been more than 30 days since the user visited the restaurant (i.e., P(B|¬A)=0.4) (sometimes referred to as a “false positive”).

With this data, it is possible to infer a probability of a successful advertisement, given that it has been more than 30 days since the user last visited the restaurant according to Bayes theorem. The formula for Bayes theorem follows:

$$P ( A \vert B ) = \frac{P ( A ) \cdot P ( B \vert A )}{P ( A ) \cdot P ( B \vert A ) + P ( ¬ A ) \cdot P ( B \vert ¬ A )} = \frac{P ( A ) \cdot P ( B \vert A )}{P ( B )}$$

Accordingly, based on the illustration, P(A|B) is about 0.156, meaning that if advertisements for the restaurant are only sent to users when it is been more than 30 days since the user last ate at the restaurant, about 156 out of 1000 advertisements are likely to be successful. Comparing P(A|B) with P(A) (representing successful advertisements without knowledge of user frequency) shows that the targeted advertising scheme of this illustration approximately triples the success of the advertisements (e.g., compare 50 out of 1000 successful advertisements, with 156 out of 1000 successful advertisements). In addition to computing P(A|B), in some embodiments, the control data 800 can further be used to compute a sensitivity (e.g., an accuracy of the prediction model (P(B|A)/P(A))), and a specificity (e.g., a false positive rate (e.g., P(B|¬A)/P(¬A)).

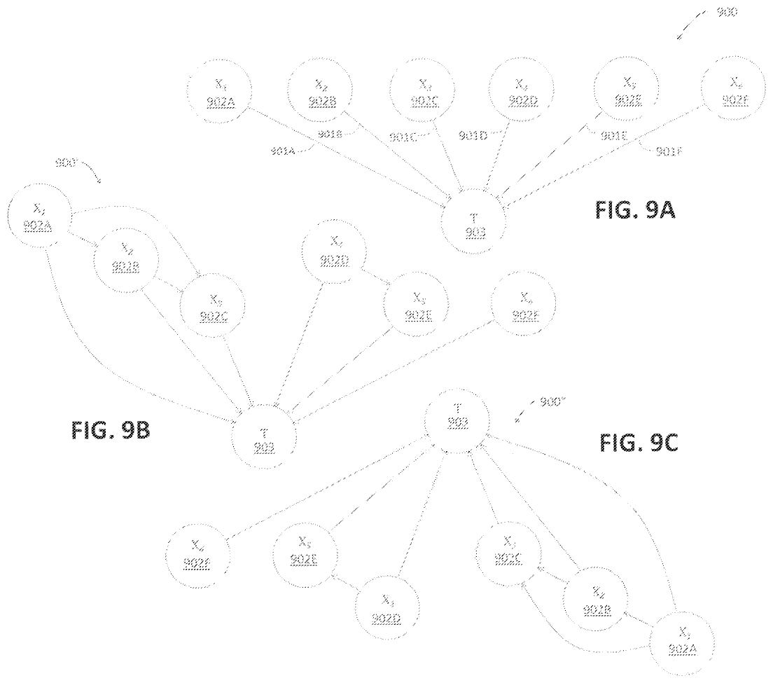

With reference to FIGS. 9A-C, in more complex models, Bayes theorem can be used to predict the probability of a target (T) occurring (e.g., the probability of a potential customer purchasing a product or service based on an advertisement) based on a plurality of causal factors or variables, sometimes referred to as predictors or factors (Xₙ). Accordingly, in some embodiments, the predictors can be linked to the target, and potentially to each other, to form a Bayesian network 900. Like the previous example, in some embodiments, the Bayesian network 900, sometimes referred to as a belief network or causal network, can represent a form of supervised learning used to model uncertainties through directed acyclic graphs including links 901 between nodes 902, 903 (representing the predictors and target), as well as the initial probabilities are established based on control data 800 (as depicted in FIG. 8) (e.g., gathered in part from a user transaction history of the mobile money management system 100). In such cases, the control data 800 can be used to map the predictors 902 to the target 903.

In the simplest case, all of the predictor nodes 902A-F can be independent from one another, in that a combination of any two predictors does not increase the probability of the target node 903 occurring. This type of network (as depicted in FIG. 9A) is sometimes referred to as a naïve Bayesian network 900. In more complex systems, there may be a connection between two or more of the predictor nodes 902. For example, it may be found that the probability of the target node 903 occurring is relatively low when either 902A or 902B (representing X₁ or X₂) occurs independently, but that the probability of the target node 903 occurring jumps unexpectedly when both 902A and 902B occur. In this case, a link may be established between 902A and 902B. This type of networks (as depicted in FIG. 9B) is sometimes referred to as an augmented naïve Bayesian network 900′.

As the links 901 between the predictor nodes 902A-F are initially unknown, one problem in establishing a supervised learning network is the requirement for extremely large sets of control data. Specifically, in order to establish the links between the nodes of the network, a conditional probability distribution of the target node 903 given every combination of the predictor nodes 902A-F is required. For example, if there are ten predictors, more than three million probability distributions would be required to establish a complete causal structure (without inferences). Instead, a procedure is often taken to invert the causal structure (as depicted in FIG. 9C), at least initially, by making the target node 903 the parent of the predictor nodes 902A-F. Even though inverting the causal structure violates the independence assumption, the inversion still often obtains good prediction performance.

In the example inverted augmented naïve Bayesian network 900″ of FIG. 9C, the conditional probability of the target occurring can be computed according to the following formula:

P(T|Data)=K·P(X₃|X₁,X₂,T)·P(X₂|₁,T)·P(X₁|T)·P(X₅|X₄,T)·P(X₄|T)·P(X₆|T)·P(T)

where K equals a normalizing constant. Accordingly, to establish a Bayesian network 900 from control data 800 on a set of individuals, the conditional probability distribution of each predictor node 902A-F (at least initially considered as an effect) is computed, given that the target node 903 has occurred. Once the Bayesian network 900 is established, it is possible to develop inferences using new data (e.g., data on a particular potential customer) to determine the likelihood that the target node 903 will occur based on a plurality of predictors Xₙ, such as timing (e.g., time of day, month, since last purchase, etc.), budget limits, weather, consumer confidence, brand popularity, supply/inventory, and the like.

In some embodiments, one or more other factors with the potential to impact the success of a given advertisement can be added as a random variable to increase a statistical fidelity of the model 800. For example, in some embodiments, a random probability distribution model (e.g., a stochastic model, Markov chain, Monte Carlo simulation etc.) can be used to estimate a probability of the target occurring, such that an output of target node 903 can be presented as a binomial distribution, rather than a single number.

For example, in one embodiment, a model 900 of a probability for success of a given advertisement can be based on a normal cumulative distribution curve supplied with a random variable, given a distribution mean corresponding to a known average and standard deviation of past successes based on the control data. To compute a binomial distribution, the model 900 can be run over a large number of iterations (e.g., 1000 iterations), with a probability of the target occurring computed at each iteration. A mean, median, standard deviation, and percentiles can then be calculated for the binomial distribution. Accordingly, in some embodiments, a probability density function (e.g., the probability that an initial probability determined according to a limited sampling of data will fall within a given range) can be computed.

Accordingly, the types of networks depicted in FIGS. 9A-C represent examples of supervised learning, where the algorithm designates active links between nodes to identify structure in the data. In other types of systems, the algorithm can be dynamically adjusted in an attempt to find hidden structure in the data. Such algorithms are sometimes referred to as deep learning or unsupervised learning algorithms.

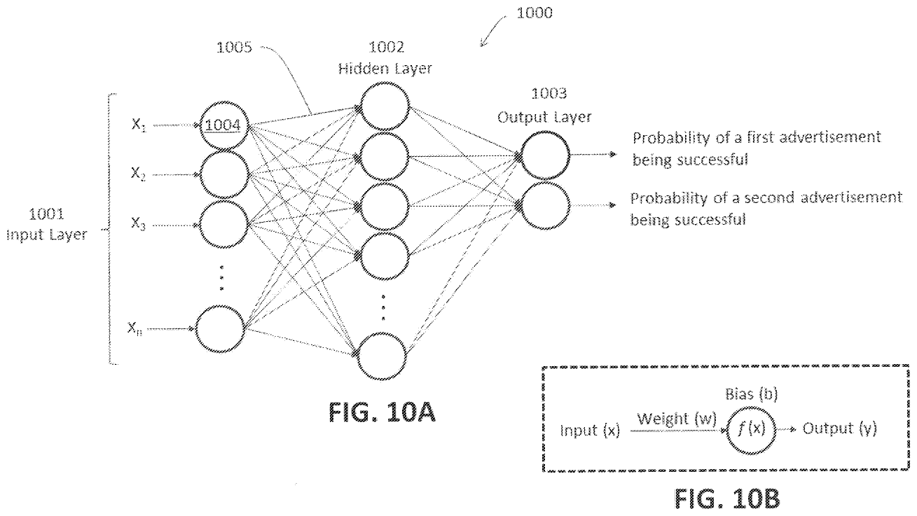

As depicted in FIG. 10A, in some embodiments, the deep learning algorithm can comprise a neural network 1000, including an input layer 1001, one or more hidden layers 1002, and an output layer 1003. Each of the layers 1001, 1002, and 1003 can include a corresponding plurality of neurons 1004. Although only a single hidden layer 1002 is depicted, it is contemplated that the neural network 1000 may include multiple hidden layers 1002. The inputs for the input layer can be a number between 0 and 1. For example, in one embodiment, the input layer 1001 can include one neuron for every potential predictor or causal factor to be evaluated, with the value of each neuron of the input layer 1001 being between 0 and 1; although other quantities of neurons and input values are also contemplated.

Each of the neurons 1004 in a layer (e.g., input layer 1001) can be connected to each of the neurons 1004 of the subsequent layer (e.g., hidden layer 1002) via a connection 1005, as such, the layers of the network can be said to be fully connected. Although it is also contemplated that the algorithm 1000 can be organized as a convolutional network, wherein one or more groups of neurons 1004 within a layer can couple to corresponding one or more single neurons 104 and a subsequent layer, wherein each of the groups has a shared weighted value.

With additional reference to FIG. 10B, each of the neurons 104 can be configured to receive one or more input values (x) and compute an output value (y). In fully connected networks, each of the neurons 104 can be assigned a bias value (b), and each of the connections 105 can be assigned a weight value (w). Collectively the weights and biases can be tuned as the neural network 1000 learns how to identify structure in the data. Each of the neurons 104 can be configured as a mathematical function, such that an output of each neuron 1004 is a function of the connection weights of the collective input, and the bias of the neuron 1004, according to the following relationship:

y≡w·x+b

In some embodiments, output (y) of the neuron 1004 can be configured to take on any value between 0 and 1. Further, in some embodiments the output of the neuron 1004 can be computed according to one of a linear function, sigmoid function, tan h function, rectified linear unit, or other function configured to generally inhibit saturation (e.g., avoid extreme output values which tend to create instability in the network 1000).

In some embodiments, the output layer 1003 can include neurons 1004 corresponding to a desired number of outputs of the neural network 1000. For example, in one embodiment, the neural network 1003 can include a single output neuron, with an output value of between 0 and 1 representing a probability of the target occurring. Other quantities of output neurons are also contemplated; for example, the output neurons could correspond to a probability of success of a variety of advertisements for different industries, products, goods or services, in which each output neuron represents the probability of each type of advertisement resulting in a sale of the advertised good or service.

The goal of the deep learning algorithm is to tune the weights and balances of the neural network 1000 until the inputs to the input layer 1004 are properly mapped to the desired outputs of the output layer 1003, thereby enabling the algorithm 1000 to accurately produce outputs (y) for previously unknown inputs (x). For example, with data gathered by the system 100 fed into the input layer 1001, one desired output of the neural network 1000 would be to indicate of probability of success in advertising, with the goal of choosing the best advertisement to present to the consumer at a specific time. In some embodiments, the neural network 1000 can rely on a sampling of training or control data (e.g., inputs with known outputs) to properly tune the weights and balances.

In tuning the neural network 1000, a cost function (e.g., a quadratic cost function, cross entropy cross function, etc.) can be used to establish how close the actual output data of the output layer 1003 corresponds to the known outputs of the training data. Each time the neural network 1000 runs through a full training data set can be referred to as one epoch. Progressively, over the course of several epochs, the weights and balances of the neural network 1000 can be tuned to iteratively minimize the cost function.

Effective tuning of the neural network 1000 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the network 1000. As a result, the backpropagation algorithm serves as a way of keeping track of small perturbations to the weights and biases as they propagate through the network, reach the output, and affect the cost. In some embodiments, changes to the weights and balances can be limited to a learning rate to prevent over fitting of the neural network 1000 (e.g., making changes to the respective weights and biases so large that the cost function overshoots the global minimum). For example, in some embodiments, the learning rate can be set between about 0.03 and about 10. Additionally, in some embodiments, various methods of regularization, such as L1 and L2 regularization, can be employed as an aid in minimizing the cost function.

Although the present disclosure specifically discusses the use of a deep learning algorithm in the form of a neural network 1000, other unsupervised learning algorithms are also contemplated. For example, in some embodiments, other methods (e.g., binary logistic regression, etc.) can be used to form the network 1000. Binary logistic regression is used to build a relationship between a binary response (i.e., the response has two categories, such as yes (1) or no (0)) and one or more predictors. Binary logistic regression is commonly used for pass/fail or event/no-event types of cases. The following summarizes basic equations behind binary logistic regression when there is only one continuous predictor.

Let x be a continuous predictor. Let a response Y be whether or not there is a fault condition, i.e., Yᵢ=0 or 1 (1 indicates an event that could be open circuit condition or short circuit condition, and 0 indicates non-event; i=1, . . . , n, where n is the sample size). Let Pᵢ be the event probability of the i-th part. Yᵢ is assumed to be Bernoulli distributed. The event probability Pᵢ can be calculated as:

Pᵢ=exp(Yᵢ*)/(1+exp(Y,′))

where, Yᵢ′=β₀+β₁cᵢ, and β₀ and β₁ are unknown coefficients in the linear regression equation between Yᵢ′ and xᵢ. By building a binary logistic regression, probability of a binary response (e.g., a conductor fracture in this case) can be estimated for a given set of predictor values.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A mobile money management system comprising:
a data engine configured to wirelessly communicate data concerning a financial transaction with a point-of-sale (PUS) terminal located at a place of business; and
a user interface configured to enable a first user to monitor financial transactions made by second user, wherein the user interface enables the first user to establish a location-based spending limit for the second user prior to the completion of any financial transactions.

2. The money management system of claim 1, wherein the user interface is configured to present a first user authorization request prior to completion of a financial transaction by the second user.

3. The money management system of claim 2, wherein the first user authorization request is based on a location of the second user.

4. The money management system of claim 2, wherein a financial transaction in proximity to the established location at or below the established spending limit does not prompt the user interface to present the first user authorization request prior to completion of the financial transaction by the second user.

5. The money management system of claim 1, wherein the user interface is configured to provide one or more notifications to the second user regarding an established spending limit at an established location.

6. The money management system of claim 1, wherein the user interface is configured to enable a user to link the mobile money management system with one or more joint financial accounts to enable records and other data concerning financial transactions entered into by the second user to be remotely monitored by the first user.

7. The money management system of claim 1, wherein the user interface is configured to enable the first to flag a particular financial transaction and to at least one of message or send details of the flag financial transaction to the second user.

8. The money management system of claim 1, wherein the user interface is further configured to present purchase related guidance to at least one of the first or second user prior to completion of the financial transaction.

9. The money management system of claim 8, wherein the purchase related guidance relates to an established spending limit associated with at least one of a method of payment or a spending category.

10. The money management system of claim 8, wherein the purchase related guidance relates to at least one of a consumer review of a product or service, a price comparison of a similar product or service at another place of business, or price comparison of a substitute product or service.
